(19) United States
(12) Patent Application Publication
(10) Pub. No.: US 2025/0321972 A1
(43) Pub. Date: Oct. 16, 2025

(54) EXPANDING THE SCOPE OF A SEARCH FUNCTION PROVIDED BY A FIRST APPLICATION TO A SECOND APPLICATION

(71) Applicant: MICROSOFT TECHNOLOGY LICENSING, LLC, Redmond, WA (US)

(72) Inventors: Siddharth GULATI, Redmond, WA (US); Kerem YUCETURK, Bellevue, WA (US); Ryan NAKHOUL, Redmond, WA (US)

(21) Appl. No.: 18/637,069

(22) Filed: Apr. 16, 2024

(51) Int. Cl. G06F 16/248

(52) U.S. Cl. CPC G06F 16/248

(57) ABSTRACT

The techniques describe expanding a scope of a search to a domain associated with a guest application that is external to a domain associated with a host application. The host application receives a search query via a search field displayed in a first portion of a graphical user interface that is managed by the host application. The host application determines that the guest application is currently managing a second portion of the graphical user interface at a time when the search query is received. The host application determines that the guest application has registered with a search handler exposed by the host application to enable the domain associated with the guest application to be scoped for the search. The host application then passes the search query to the guest application, thereby enabling the guest application to render a search results page via the second portion of the graphical user interface.

Recently, developers and/or providers of application are enabling user experiences offered within a first application to expand to a second application. That is, the second application can execute its own functions and display its own content in the “context” of the first application. The “context” of the first application means that the first application still manages the user experience while the second application executes its own functions and displays its own content. For example, the graphical user interface (e.g., an application window) continues to reflect and be managed by the first application while the second application executes its own functions and displays its own content.

When the second application executes its own functions and display its own content in the context of the first application, the first application can still provide its own functions. One of the functions the first application still provides is a search function. Accordingly, the search function is scoped to a domain of the first application. A domain defined application-based and/or application function-based boundaries for the search. Stated alternatively, the search function provided by the first application cannot be scoped to a domain of the second application when the second application is executing its own functions and displaying its own content in the context of the first application. It is with respect to these and other considerations that the disclosure made herein is presented.

### SUMMARY

The techniques disclosed herein expand the scope of a search function provided, or offered, by a first application to a second application that is configured to execute its own functions and display its own content in the context of the first application. The first application may be referred to herein as a “host” application and the second application may be referred to herein as a “guest” application. As described above, the scope of the search function provided by the host application is typically limited to a domain associated with the host application. Accordingly, a user engaging in an experience with the host application cannot perform a search that is scoped to a domain associated with the guest application when the guest application is executing its own functions and displaying its own content in the context of the host application. The expansion of the scope of the search function essentially enables guest applications to onboard their search functions to a user experience offered by the host application.

As further described herein, the search function provided by the host application includes a search field. The search field is provided via a portion of a graphical user interface (e.g., application window) that is managed by the host application. This portion of the graphical user interface is referred to herein as the “search” portion. The graphical user interface includes another portion for which management can be passed, based on user input, from the host application to a guest application. In this way, the guest application can execute its own functions and display its own content in the context of the host application. This other portion of the graphical user interface is referred to herein as the “user focus” portion. In various examples, the host application requires a user input that grants privileges for a guest application to manage the user focus portion of the graphical user interface. In further examples, the host application requires another user input that grants privileges for the guest application to onboard its search function to the user experience offered by the host application.

As described herein, the host application is configured to receive a search query via the search field. In response to the search query being received, the host application determines that a guest application is currently managing the user focus portion of the graphical user interface at a time when the search query is received. Next, the host application determines that the guest application has registered with a search handler exposed by the host application. In various examples, the host application exposes a plurality of search handlers for guest applications that have been granted privileges to execute in the context of the host application. When a user provides a request, e.g., via a first user input, for the host application to pass management of the user focus portion of the graphical user interface to the guest application, the host application can be configured to seek search permission, via a prompt, from the user which allows the guest application to register with the search handler. After the user grants the search permission via a second user input implemented with respect to the prompt, the guest application is allowed to register with the search handler. The registration process includes designating an identification of the guest application and a callback function associated with searching. Accordingly, the host application receives the registration via the search handler after management of the user focus portion of the graphical user interface is passed from the host application to the guest application and after the user has granted the search permission for the guest application to perform its own searches in the context of the host application. In various examples, the granting of the search permission by the user is a one-time operation. Once completed, any subsequent search execution no longer prompts the user for search permission since it has been previously granted and already exists.

In response to determining that the guest application has registered with the search handler, the host application passes the search query, previously received via the search field, from the host application to the guest application. In one example, the search query is passed from the host application to the guest application via the callback function associated with searching. Using the passed search query, the guest application is able to manage its own search and render a search results page via the user focus portion of the graphical user interface currently being managed by the guest application. Consequently, the registration enables the search function that is provided by the host application, and that previously could only be scoped to a domain associated with the host application, to expand to a domain that is external to the host application. Stated alternatively, an expanded search across different application domains is seamlessly implemented using the techniques described herein.

In various examples, the search field displayed in the search portion of the graphical user interface that is managed by the host application displays a graphical user interface element (e.g. a “pill” element) identifying the guest application while the guest application is currently managing the user focus portion of the graphical user interface. For instance, the host application can display the identification (e.g., name) of the guest application and/or an icon (e.g., a logo) for the guest application so that a user can distinguish between searchable domains. The graphical user interface element effectively informs a user of the dynamic nature of searchable domains. If a user wishes to search a domain associated with the host application while the guest application is managing the user focus portion, the user can interact with the graphical user interface element (e.g., dismiss the graphical user interface element) to switch the scope of the search from the domain associated with the guest application to the domain associated with the host application.

In further examples, the host application is configured to receive, from the guest application via the search handler, an indication that the user has exited the search results page that is rendered by the guest application. Based on this indication, the host application can clear the search field. That is, the host application can remove the search query from the search field that is displayed in the search portion of the graphical user interface.

One of the technical benefits of the present disclosure includes improving a user experience, and conserving computing resources (e.g., processing resources, storage resources, networking resources), by not requiring a user to leave the user experience provided by the host application to implement a search with respect to a guest application. Conventionally, if a user wishes to implement a search function that is scoped to a domain associated with a guest application while the guest application is executing its own functions and displaying its own content in the context of a host application, the user must leave the context of the host application to implement the search. Consequently, the user is required to switch between user experiences, e.g., the search query is typically received and the search results page is typically rendered via an application that is external to the host application (e.g., a browser application, the guest application itself). Accordingly, the user experience within the context of the host application is interrupted and frustrated, and unnecessary computing resources are expended.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a diagram illustrating an environment in which the scope of a search function provided, or offered, by a host application is expanded to a guest application that is configured to execute its own functions and display its own content in the context of the host application.

FIG. 2 is a diagram illustrating an example timing sequence for expanding the scope of the search function.

FIG. 3A illustrates an example graphical user interface of a guest application executing its own functions and displaying its own content in the context of a host application even though the host application retains management control over the search function.

FIG. 3B illustrates a continuance of the example graphical user interface of FIG. 3A in which the user is taking steps to enter a search query in a search field.

FIG. 3C illustrates a continuance of the example graphical user interface of FIG. 3B in which the user has entered the search query in the search field.

FIG. 3D illustrates a continuance of the example graphical user interface of FIG. 3C in which the guest application has rendered a search results page based on a search implemented in its own domain.

FIG. 3E illustrates a continuance of the example graphical user interface of FIG. 3D in which the user exits the search results page, and accordingly, the search field is cleared.

FIG. 4 is a flow diagram showing aspects of a process for expanding the scope of a search function provided by the host application to the guest application that is configured to execute its own functions and display its own content in the context of the host application.

FIG. 5 is a computer architecture diagram illustrating an illustrative computer hardware and software architecture for a computing system capable of implementing aspects of the techniques and technologies presented herein.

### DETAILED DESCRIPTION

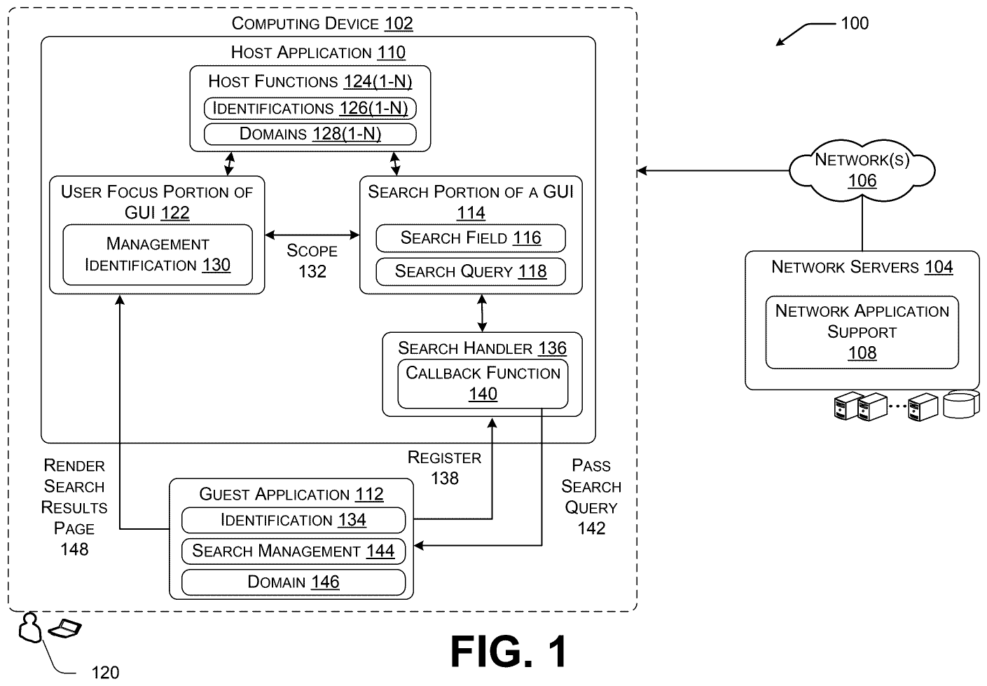

The techniques and technologies disclosed herein expand the scope of a search function provided, or offered, by a first application to a second application that is configured to execute its own functions and display its own content in the context of the first application. As described above, the first application may be referred to herein as a “host” application and the second application may be referred to herein as a “guest” application. As further described above, the scope of the search function provided by the host application is typically limited to a domain associated with the host application. Accordingly, a user engaging in an experience with the host application cannot perform a search that is scoped to a domain associated with the guest application when the guest application is executing its own functions and displaying its own content in the context of the host application. Various examples, scenarios, and aspects of the disclosed techniques that expand the scope of the search function across different application domains are described below with reference to FIGS. 1-5.

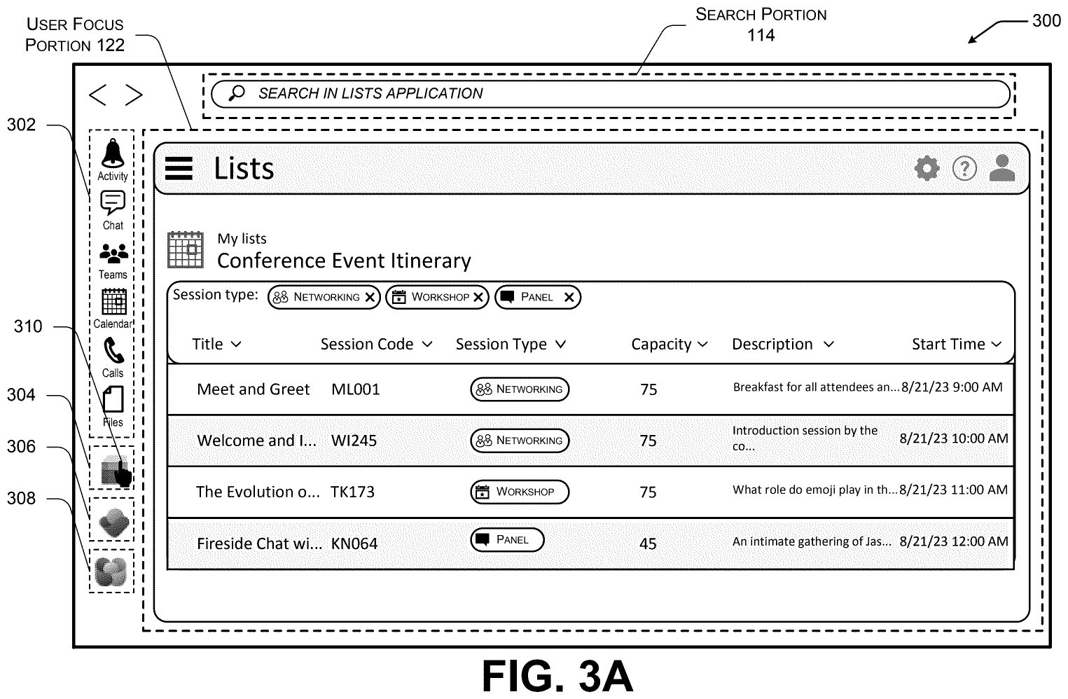

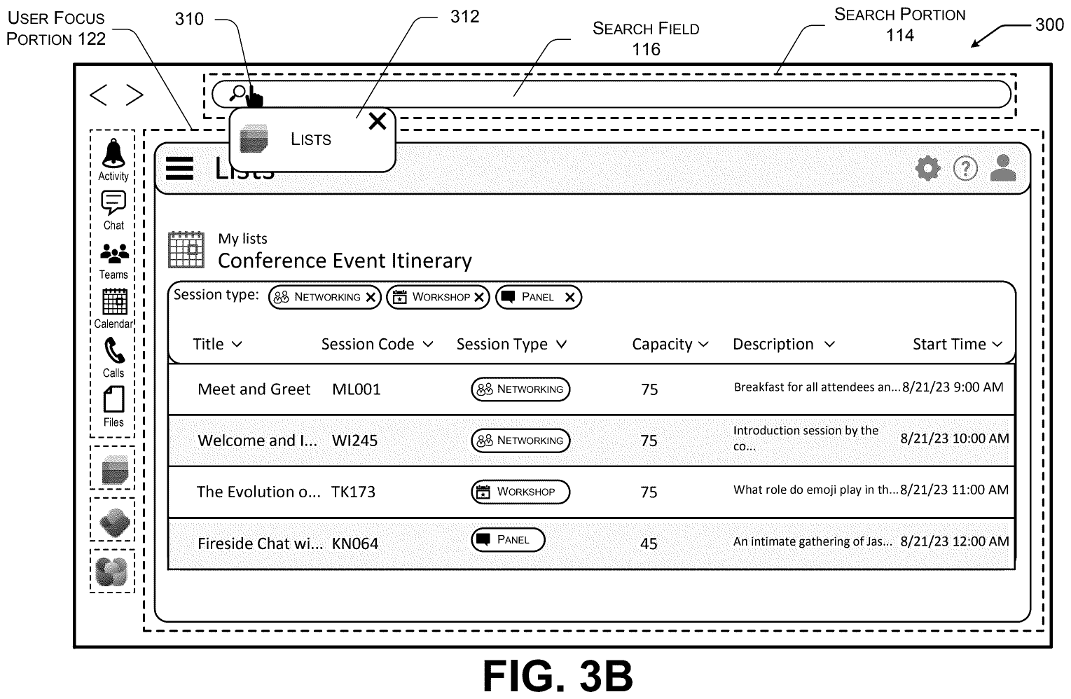

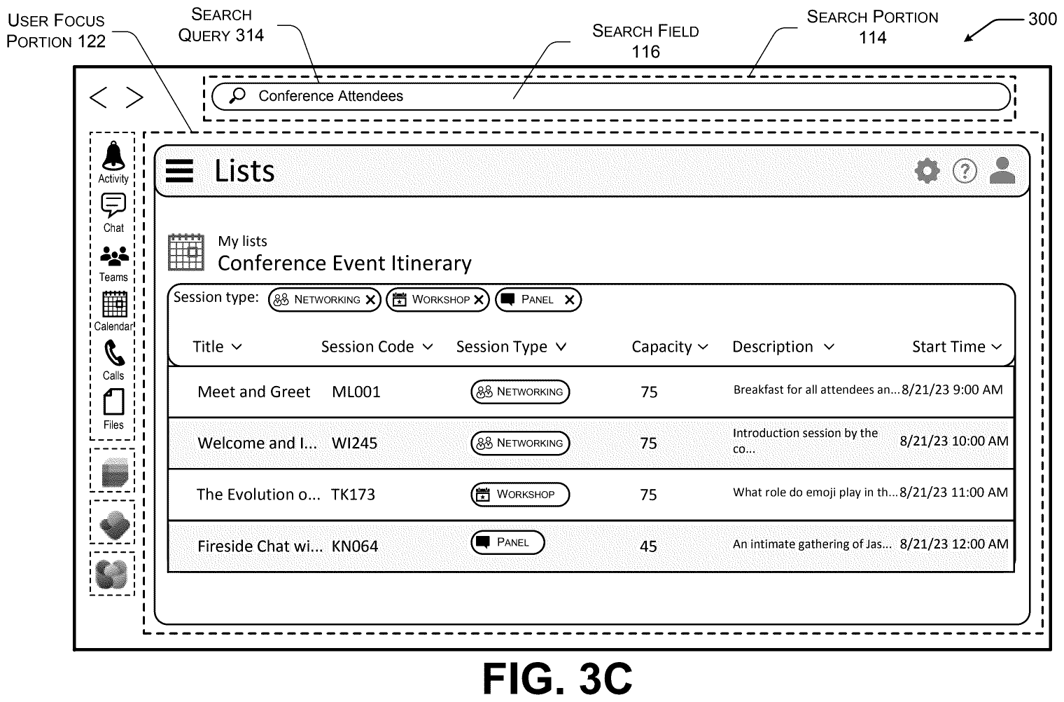

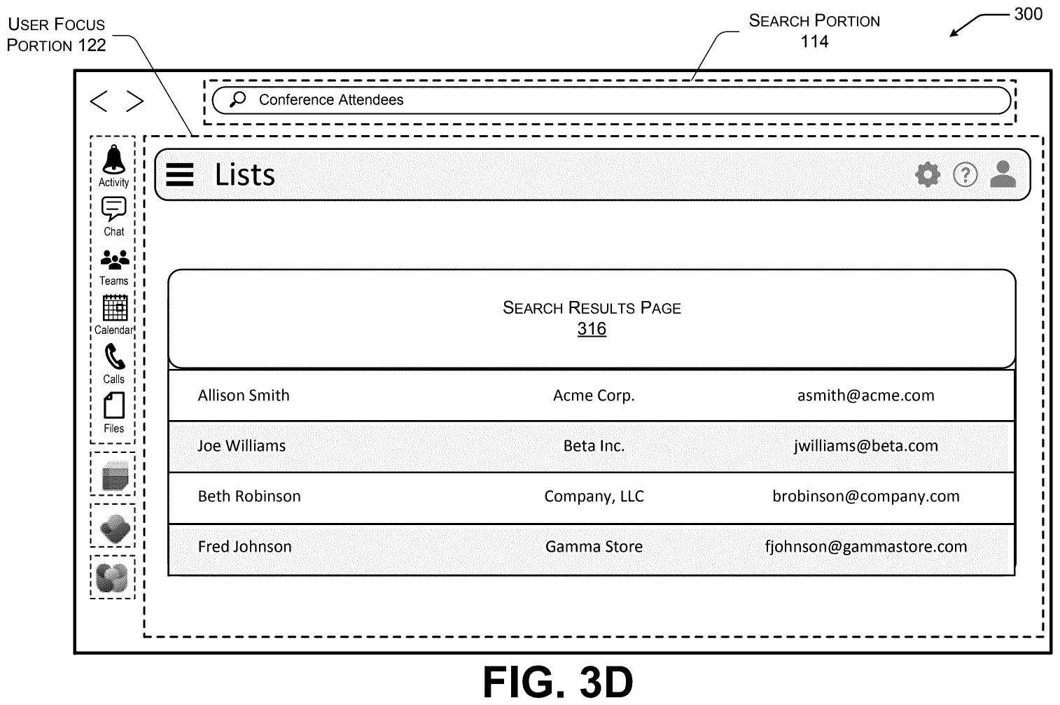

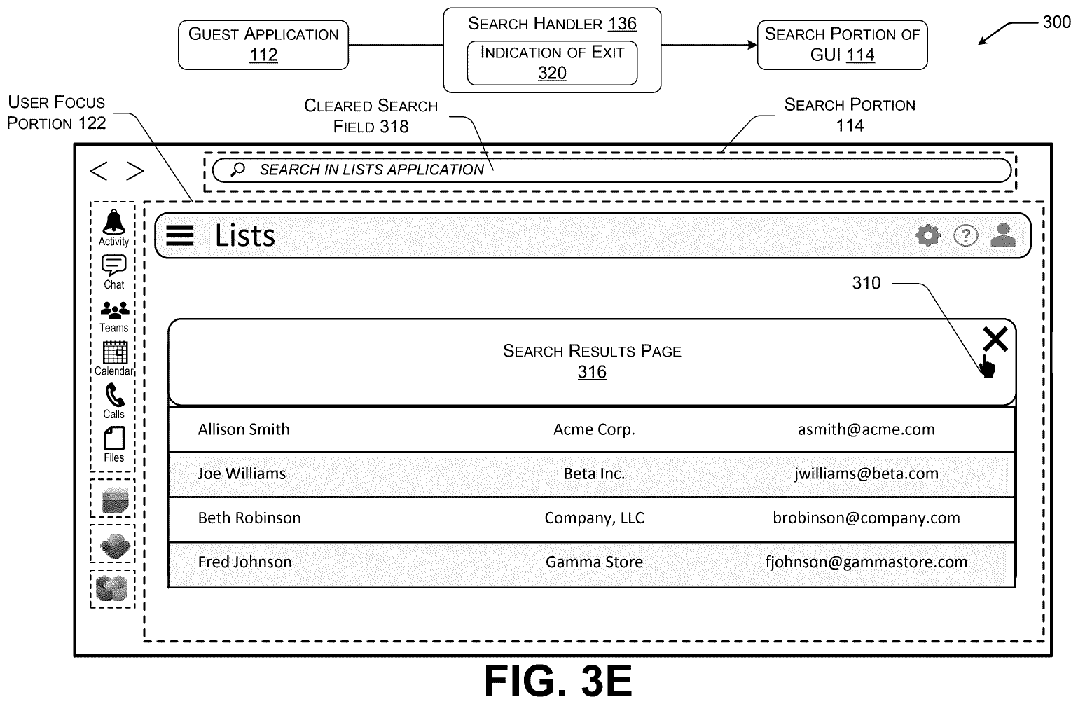

FIG. 1 illustrates an environment 100 that includes a computing device 102 and, in various examples, network servers 104 that can be connected to the computing device 102 via network(s) 106. The network servers 104 are configured to provide network application support 108 for a host application 110 and/or a guest application 112. The host application 110 is configured to display a graphical user interface (GUI) during execution, examples of which are described below with respect to FIGS. 3A-3E. The host application is further configured to provide, or offer, a search function via a search portion 114 of the GUI. The search portion 114 of the GUI includes a search field 116 that is configured to receive a search query 118 based on input from a user 120 of the computing device 102.

The GUI displayed by the host application 110 further includes a user focus portion 122 of the GUI. The user focus portion 122 of the GUI typically consumes more display space than the search portion 114 of the GUI. Moreover, the user focus portion 122 is the primary area of the GUI with which the user 120 engages (e.g., focuses their eye gaze, focuses their computer-based interactions such as scrolling and clicks), hence the reason this portion is referred to as the “user focus” portion 122.

Typically, the scope of the search function provided by the host application 110 is limited to a domain associated with the host application 110. For instance, the host application 110 may provide host functions 124(1-N) (where N is a positive integer). In the examples of FIG. 3A-3E discussed below, the host functions 124(1-N) include activities, chat, teams, calendar, calls, and the storage of files. The host functions 124(1-N) respectively include separate identifications 126(1-N) and domains 128(1-N). Based on user input, the user focus portion 122 of the GUI can switch between displaying content of one host function 124(1) (e.g., the user's chat threads) to displaying content of another host function 124(2) (e.g., the user's calendar).

FIG. 1 shows that the user focus portion 122 of the GUI is associated with a management identification 130. The management identification 130 is used to scope 132 the search function. That is, a search query 118 received via the search field 116 is scoped 132 to a domain associated with the management identification 130. If the management identification 130 references an identification 126(1) for host function 124(1) and the host function 124(1) defines boundaries around the user's chat threads to create a corresponding chat domain 128(1), then the host application 110 searches the user's chat threads based on the search query 118 and displays corresponding search results. Similarly, if the management identification 130 references an identification 126(2) for host function 124(2) and the host function 124(2) defines boundaries around the user's calendar to create a corresponding calendar domain 128(2), then the host application 110 searches the user's calendar based on the search query 118 and displays corresponding search results. Accordingly, the scope 132 of a search can dynamically change based on which host function 124(1-N) the user 120 is engaging with via the user focus portion 122 of the GUI.

In various examples, the management identification 130 can also reference an identification 134 for the guest application 112. In this way, the guest application 112 can execute its own functions and display its own content via the user focus portion 122 of the GUI, e.g., in the context of the host application 110. The guest application 112 may be a first party application (i.e., a separate application that is developed and/or operated by the same entity that develops and/or operates the host application 110) or a third party application (i.e., a separate application that is developed and/or operated by a different entity compared to the entity that develops and/or operates the host application 110).

Even though the management of the user focus portion 122 of the GUI can be passed from the host application 110 to the guest application 112, the scope 132 of the search function is limited to the host application 110, thereby interrupting and/or frustrating the user experience when the user is engaging with the guest application 112. To expand the scope of the search function to include the guest application 112, the host application 110 exposes a search handler 136. The guest application 112 is allowed to register 138 its identification 134 and a callback function 140 with the search handler 136. When the host application 110 receives a search query 118 via the search field 116, the host application 110 determines that the guest application 112 is currently managing the user focus portion 122 of the GUI by checking the management identification 130, which references the identification 134 of the guest application 112 (e.g., opposed to the identifications 126(1-N) of the host functions 124(1-N)).

The host application 110 then determines that the guest application 112 has registered 138 with the search handler 136. In response to determining that the guest application 112 has registered 138 with the search handler 136, the host application 110 passes 142 the search query 118 received via the search field 116 to the guest application 112. In one example, the search query 118 is passed from the host application 110 to the guest application 112 via the callback function 140. Using the passed search query, the guest application 112 is able to implement its own search management 144 with respect to its own domain 146. Moreover, based on the passed search query 118, the guest application 112 can render 148 a search results page via the user focus portion 122 of the GUI currently being managed by the guest application 112.

Consequently, the registration 138 enables the search function that is provided by the host application 110, and that previously could only be scoped to a domain 128(1-N) associated with the host application 110, to expand to a domain 146 that is external to the host application 110. Stated alternatively, using the techniques described herein, guest applications are enabled to essentially onboard their own search functions to a user experience offered by the host application 110 to seamlessly implement searches across different application domains.

In various examples, the host application 110 requires a user input (from the user 120) that grants privileges for the guest application 112 to manage the user focus portion 122 of the GUI. In further examples, the host application 110 requires another user input (from the user 120) that grants privileges for the guest application 112 to onboard its search function to the user experience offered by the host application 110. For instance, the user 120 may request, e.g., via a first user input, for the host application 110 to pass management of the user focus 122 to the guest application 112. When this occurs, the host application 110 can be configured to seek search permission, via a prompt, from the user 120 which allows the guest application 112 to register with the search handler 136. After the user 120 grants the search permission via a second user input implemented with respect to the prompt, the guest application 112 is allowed to register with the search handler 136. Accordingly, the host application 110 receives the registration via the search handler 136 after management of the user focus portion 122 is passed from the host application 110 to the guest application 112 and after the user 120 has granted the search permission for the guest application 112 to perform its own searches in the context of the host application 110. In various examples, the granting of the search permission by the user 120 is a one-time operation. Once completed, any subsequent search execution no longer prompts the user 120 for search permission since it has been previously granted and already exists. Accordingly, the host application 110 implements a check to determine whether the user 120 has granted the search permission before executing the search. If the search permission has been granted, the host application 110 passes the search query 118 to the guest application 112. If the search permission has not been granted, then the search query 118 is not passed to the guest application 112. Rather, the search is implemented internally within the host application 110.

One of the technical benefits of the present disclosure includes improving a user experience, and conserving computing resources (e.g., processing resources, storage resources, networking resources), by not requiring the user 120 to leave the user experience provided by the host application 110 to implement a search with respect to a guest application 112. Conventionally, if a user wishes to implement a search function that is scoped to a domain associated with a guest application while the guest application is executing its own functions and displaying its own content in the context of a host application, the user must leave the context of the host application to implement the search. Consequently, the user is required to switch between user experiences, e.g., the search query is typically received and the search results page is typically rendered via an application that is external to the host application (e.g., a browser application, the guest application itself). Accordingly, the user experience within the context of the host application is interrupted and frustrated, and unnecessary computing resources are expended.

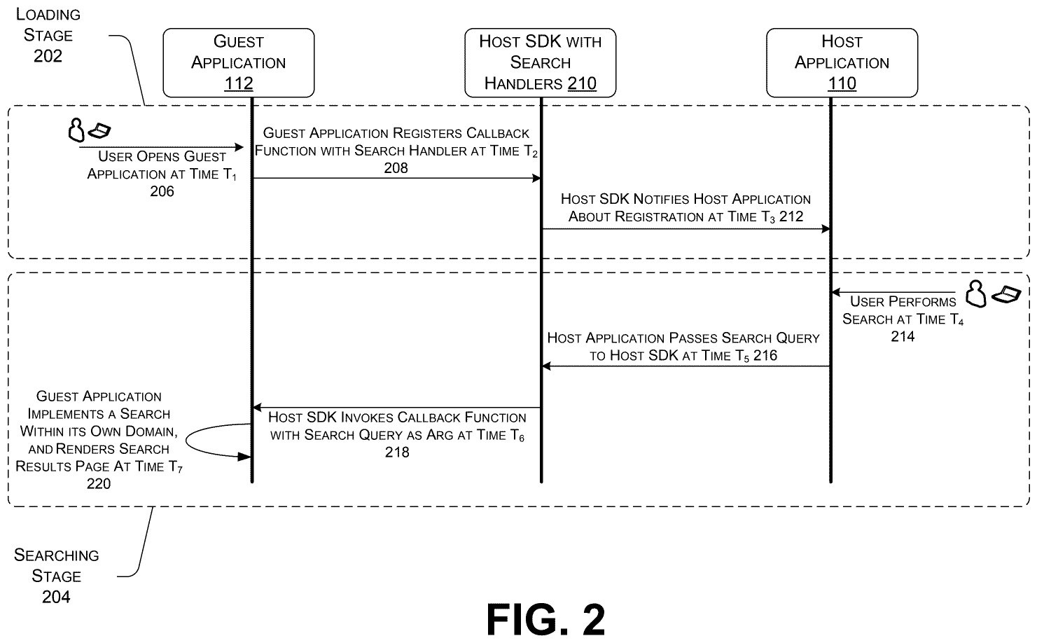

FIG. 2 is a diagram illustrating an example timing sequence for expanding the scope of the search function. The timing sequence is separated into a loading stage 202 and a searching stage 204 that occurs after the loading stage. The loading stage 202 begins at 206 where, at time t₁, the user 120 opens the guest application 112 in the context of the host application 110. At time t₂, the guest application 112 registers a callback function 140 (e.g., “search.queryExecute”) with the search handler 136, as referenced by 208.

In various examples, the host application 110 is configured with a host Software Development Kit (SDK) 210 that exposes a plurality of different search handlers to which different guest applications can register. The host SDK 210 contains contract details for the search handlers and acts as a bridge between the host application 110 and the guest application 112. Moreover, the SDK manages communication between the host application 110 and the guest application 112.

The loading stage 202 continues at 212 where, at time t₃, the host SDK 210 notifies the host application 110 about the registration of the callback function. This essentially ends the loading stage 202, as the guest application 112 is executing in the context of the host application 110 and the guest application 112 has communicated its intent to manage its own search in the contest of the host application 110 via the registration.

The searching stage 204 begins at 214 where, at time t₄, the user 120 performs a search (e.g., the user 120 provides a search query 118 via the search field 116 and presses/selects a submission key/GUI element). At time t₅, the host application 110 passes the search query 118 to the host SDK 210, as referenced by 216. The host SDK 210 receives the search query 118 and, at time to, invokes the callback function 140 that has been registered by the guest application 112 with the search query 118 being the argument, as referenced by 218. The guest application 112 receives the search query 118 via the callback function 140, implements its own search within its own domain, and renders a search results page via the user focus portion 122 of the GUI at time t₇, as referenced by 220.

FIG. 3A is an example GUI 300 showing a guest application executing its own functions and displaying its own content in the context of a host application even though the host application retains management control over the search function. In the examples of FIGS. 3A-3E, the host application 110 is a collaboration application for users. However, it is understood in the context of this disclosure, that the host application 110 can be any type of application.

The GUI 300 includes the search portion 114 and the user focus portion 122. In various examples, the GUI 300 includes other portions, such as a portion 302 for the host functions 124(1-N) and portions 304, 306, 308. Portion 302 includes selectable GUI elements representing activities, chats, teams, a calendar, calls, and the storage of files. Each of portions 304, 306, 308 represent a selectable GUI element for different guest applications. In this example, the user 120 controls a cursor 310 to select, via portion 304, a guest application “Lists”. Accordingly, the guest application “Lists” is opened in the context of the host application 110 and the functions and/or the content displayed in the user focus portion 122 of the GUI 300 is managed by the guest application “Lists”. That is, the guest application “Lists” is displaying information and functions related to a conference event itinerary for the user 120. Furthermore, upon changing the management of the user focus portion 122, the host application 110 can change the “placeholder” text in the search portion 114 to identify the guest application “Lists”. For example, the host application 110 can change the default placeholder text “Search in host application” to “Search in guest application Lists”. Updated placeholder text educates the user 120 about the existence of the techniques described herein and can encourage the user 120 to perform the search via a guest application.

Proceeding to FIG. 3B, which is a continuance of the example GUI 300 of FIG. 3A, the user 120 moves the cursor 310 towards and/or into the search field 116 displayed in the search portion 114, thereby indicating an intent to enter a search query 118. As described above, even though the host application 110 has passed management of the user focus portion 122 to the “Lists” application, the search function implemented via the search portion 114 remains in control of the host application 110.

Based on the aforementioned movement of the cursor 310, as well as implementation of the loading stage 202 in FIG. 2, the host application 110 is configured to display a GUI element 312 (e.g. a “pill” element) identifying the guest application that is currently managing the user focus portion 122 of the GUI 300. For instance, the host application 110 can display the name of the guest application (e.g., “Lists”) and/or an icon (e.g., the “Lists” logo) for the guest application in the GUI element 312 so that the user 120 can distinguish between active searchable domains. The GUI element 312 effectively informs the user 120 of the dynamic nature of searchable domains. If a user wishes to search a domain associated with the host application 110 while the guest application “Lists” is managing the user focus portion 122, the user can interact with the GUI element 312 (e.g., dismiss the GUI element 312 via the “X”) to switch the scope of the search from the domain associated with the guest application “Lists” to the domain associated with the host application 110.

Proceeding to FIG. 3C, which is a continuance of the example GUI 300 of FIG. 3B, the user 120 has entered and submitted a search query 314-“Conference Attendees”-in the search field 116. The host application 110 receives the search query 314 and determines that the guest application “Lists” is currently managing the user focus portion 122 of the GUI 300 at a time when the search query 314 is received. Furthermore, the host application determines that the guest application “Lists” has registered a callback function 140 with a search handler 136 that the host application 110 has exposed to enable guest applications to search their own domains.

In response to determining that the guest application “Lists” has registered the callback function 140 with the search handler 136, the host application 110 passes the search query 314—“Conference Attendees”—to the guest application “Lists”. This enables the guest application “Lists” to manage its own search of its own domain 146 and render a search results page 316 for the search query 314 via the user focus portion 122 of the GUI, as shown in FIG. 3D. In this example, the search results page 316 includes a list of conference attendees that is stored within a searchable domain of the guest application “Lists”.

FIG. 3E illustrates a continuance of the example GUI 300 of FIG. 3D, in which the user 120 exits the search results page 316, and accordingly, the search field is cleared 318. FIG. 3E illustrates how the search handler 136 serves as a mechanism to enable two-way communications between the guest application 112 and the search portion 114 of the GUI 300. One direction of the two-way communications is captured by the passing of the search query 314 from the host application 110 to the guest application 112. However, the guest application 112, such as the guest application “Lists”, can also use the search handler to communicate in the opposite direction. For example, the user 120 may control the cursor 310 to exit out of the search results page 316, as shown in FIG. 3E via the selection of the “X”. Since the guest application “Lists” is managing the user focus portion 122, the guest application “Lists” provides an indication 320 that the user 120 has exited the search results page 316 to the search handler 136. The host application 112 receives, from the guest application “Lists” via the search handler 136, the indication 320 that the user 120 has exited the search results page 316. Based on this indication 320, the host application 110 can clear 318 the search field. That is, the host application 110 can remove the search query 314-“Conference Attendees”—from the search field 316.

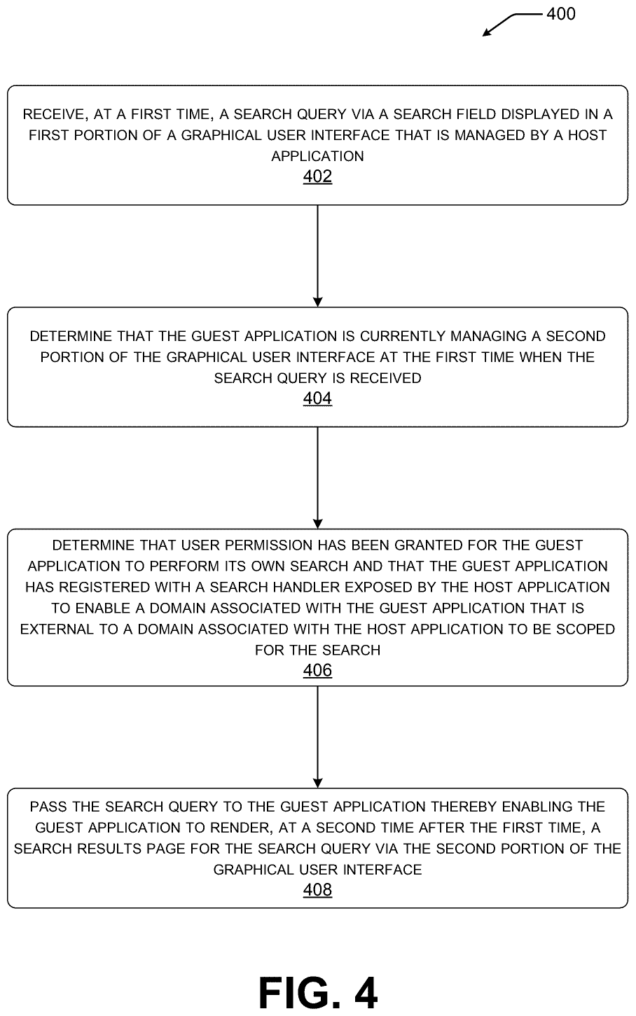

Proceeding to FIG. 4, aspects of a process 400 for expanding the scope of a search function provided by a host application to a guest application that is configured to execute its own functions and display its own content in the context of the host application. With respect to FIG. 4, the process 400 begins at operation 402 where a host application executing on a computing device receives, at a first time, a search query via a search field displayed in a first portion of a graphical user interface that is managed by the host application.

At operation 404, the host application determines that the guest application is currently managing a second portion of the graphical user interface at the first time when the search query is received.

At operation 406, the host application determines that user permission has been granted for the guest application to perform its own search and that the guest application has registered with a search handler exposed by the host application to enable a domain associated with the guest application that is external to a domain associated with the host application to be scoped for the search.

At operation 408, the host application passes the search query to the guest application thereby enabling the guest application to render, at a second time after the first time, a search results page for the search query via the second portion of the graphical user interface currently being managed by the guest application.

For ease of understanding, the process discussed in this disclosure is delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 400 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 400 may also be implemented in other ways. In addition, one or more of the operations of the process 400 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

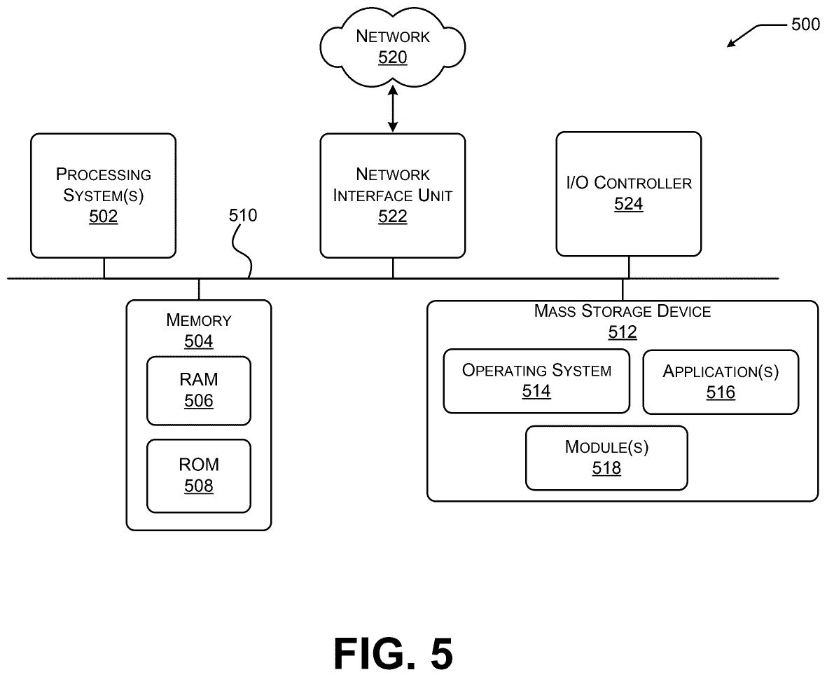

FIG. 5 shows additional details of an example computer architecture 500 for a device, such as the computing device 102, capable of executing computer instructions. The computer architecture 500 illustrated in FIG. 5 includes processing system 502, a system memory 504, including a random-access memory 506 (RAM) and a read-only memory (ROM) 508, and a system bus 510 that couples the memory 504 to the processing system 502. The processing system 502 comprises processing unit(s).

Processing unit(s), such as processing unit(s) of processing system 502, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 500, such as during startup, is stored in the ROM 508. The computer architecture 500 further includes a mass storage device 512 for storing an operating system 514, application(s) 516, modules 518, and other data described herein.

The mass storage device 512 is connected to processing system 502 through a mass storage controller connected to the bus 510. The mass storage device 512 and its associated computer-readable media provide non-volatile storage for the computer architecture 500. Although the description of computer-readable media contained herein refers to a mass storage device, the computer-readable media can be any available computer-readable storage media or communication media that can be accessed by the computer architecture 500.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

The software components described herein may, when loaded into the processing system 502 and executed, transform the processing system 502 and the overall computer architecture 500 from a general-purpose computing system into a special-purpose computing system customized to facilitate the functionality presented herein. The processing system 502 may be constructed from any number of transistors or other discrete circuit elements, which may individually or collectively assume any number of states. More specifically, the processing system 502 may operate as a finite-state machine, in response to executable instructions contained within the software modules disclosed herein. These computer-executable instructions may transform the processing system 502 by specifying how the processing system 502 transition between states, thereby transforming the transistors or other discrete hardware elements constituting the processing system 502.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different applications).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for scoping a search to a first domain associated with a guest application that is external to a second domain associated with a host application, the method comprising:
receiving, by the host application and at a first time, a search query via a search field displayed in a first portion of a graphical user interface that is managed by the host application;
determining, by the host application, that the guest application is currently managing a second portion of the graphical user interface at the first time when the search query is received;
determining, by the host application, that the guest application has registered with a search handler exposed by the host application to enable the first domain associated with the guest application that is external to the second domain associated with the host application to be scoped for the search; and
in response to determining that the guest application has registered with the search handler, passing, by the host application, the search query to the guest application thereby enabling the guest application to render, at a second time after the first time, a search results page for the search query via the second portion of the graphical user interface currently being managed by the guest application.

2. The method of claim 1, further comprising:
exposing, by the host application, a plurality of search handlers that includes the search handler;
receiving, by the host application and at a third time that is before the first time, a user input requesting that the host application pass management of the second portion of the graphical user interface to the guest application; and
allowing, by the host application and based at least in part on the receiving the user input, the guest application to register with the search handler using an identification of the guest application and a callback function, wherein the search query is passed from the host application to the guest application via the callback function.

3. The method of claim 1, wherein the search field displayed in the first portion of the graphical user interface that is managed by the host application displays a graphical user interface element identifying the guest application while the guest application is currently managing the second portion of the graphical user interface.

4. The method of claim 1, wherein:
a first user input grants first privileges for the guest application to manage the second portion of the graphical user interface; and
a second user input grants second privileges to have the search query passed from the host application to the guest application thereby enabling the guest application to render the search results page for the search query via the second portion of the graphical user interface currently being managed by the guest application.

5. The method of claim 1, further comprising:
receiving, by the host application and from the guest application, an indication that a user has exited the search results page rendered by the guest application; and
removing, by the host application, the search query from the search field displayed in the first portion of the graphical user interface based on the indication.

6. The method of claim 1, wherein the first portion of the graphical user interface is limited to a search function that continues to be managed by the host application while the guest application is currently managing the second portion of the graphical user interface.

7. The method of claim 1, wherein the second portion of the graphical user interface is manageable by a plurality of different applications based on user input selecting a specific application and signaling a user intention to focus engagement on the specific application.

8. The method of claim 1, further comprising replacing default placeholder text in the search field with placeholder text that identifies the guest application responsive to determining that the guest application is currently managing the second portion of the graphical user interface and determining that the guest application has registered with the search handler.

9. A computing device comprising:
a processing system; and
a computer-readable medium storing instructions that, when executed by the processing system, cause the computing device to perform operations comprising:
receiving, by a host application executing via the computing device and at a first time, a search query via a search field displayed in a first portion of a graphical user interface that is managed by the host application;
determining, by the host application, that a guest application is currently managing a second portion of the graphical user interface at the first time when the search query is received;
determining, by the host application, that the guest application has registered with a search handler exposed by the host application to enable a first domain associated with the guest application that is external to a second domain associated with the host application to be scoped for a search; and
in response to determining that the guest application has registered with the search handler, passing, by the host application, the search query to the guest application thereby enabling the guest application to render, at a second time after the first time, a search results page for the search query via the second portion of the graphical user interface currently being managed by the guest application.

10. The computing device of claim 9, wherein the operations further comprise:
exposing, by the host application, a plurality of search handlers that includes the search handler;
receiving, by the host application and at a third time that is before the first time, a user input requesting that the host application pass management of the second portion of the graphical user interface to the guest application; and
allowing, by the host application and based at least in part on the receiving the user input, the guest application to register with the search handler using an identification of the guest application and a callback function, wherein the search query is passed from the host application to the guest application via the callback function.

11. The computing device of claim 9, wherein the search field displayed in the first portion of the graphical user interface that is managed by the host application displays a graphical user interface element identifying the guest application while the guest application is currently managing the second portion of the graphical user interface.

12. The computing device of claim 9, wherein:
a first user input grants first privileges for the guest application to manage the second portion of the graphical user interface; and
a second user input grants second privileges to have the search query passed from the host application to the guest application thereby enabling the guest application to render the search results page for the search query via the second portion of the graphical user interface currently being managed by the guest application.

13. The computing device of claim 9, wherein the operations further comprise:
receiving, by the host application and from the guest application, an indication that a user has exited the search results page rendered by the guest application; and
removing, by the host application, the search query from the search field displayed in the first portion of the graphical user interface based on the indication.

14. The computing device of claim 9, wherein the first portion of the graphical user interface is limited to a search function that continues to be managed by the host application while the guest application is currently managing the second portion of the graphical user interface.

15. The computing device of claim 9, wherein the second portion of the graphical user interface is manageable by a plurality of different applications based on user input selecting a specific application and signaling a user intention to focus engagement on the specific application.

16. A computer-readable medium storing instructions that, when executed by a processing system, cause the computing device to perform operations comprising:
receiving, by a host application executing via the computing device and at a first time, a search query via a search field displayed in a first portion of a graphical user interface that is managed by the host application;
determining, by the host application, that a guest application is currently managing a second portion of the graphical user interface at the first time when the search query is received;
determining, by the host application, that the guest application has registered with a search handler exposed by the host application to enable a first domain associated with the guest application that is external to a second domain associated with the host application to be scoped for a search; and
in response to determining that the guest application has registered with the search handler, passing, by the host application, the search query to the guest application thereby enabling the guest application to render, at a second time after the first time, a search results page for the search query via the second portion of the graphical user interface currently being managed by the guest application.

17. The computer-readable medium of claim 16, wherein the operations further comprise:
exposing, by the host application, a plurality of search handlers that includes the search handler;
receiving, by the host application and at a third time that is before the first time, a user input requesting that the host application pass management of the second portion of the graphical user interface to the guest application; and
allowing, by the host application and based at least in part on the receiving the user input, the guest application to register with the search handler using an identification of the guest application and a callback function, wherein the search query is passed from the host application to the guest application via the callback function.

18. The computer-readable medium of claim 16, wherein the search field displayed in the first portion of the graphical user interface that is managed by the host application displays a graphical user interface element identifying the guest application while the guest application is currently managing the second portion of the graphical user interface.

19. The computer-readable medium of claim 16, wherein:
a first user input grants first privileges for the guest application to manage the second portion of the graphical user interface; and
a second user input grants second privileges to have the search query passed from the host application to the guest application thereby enabling the guest application to render the search results page for the search query via the second portion of the graphical user interface currently being managed by the guest application.

20. The computer-readable medium of claim 16, wherein:
the first portion of the graphical user interface is limited to a search function that continues to be managed by the host application while the guest application is currently managing the second portion of the graphical user interface; and
the second portion of the graphical user interface is manageable by a plurality of different applications based on user input selecting a specific application and signaling a user intention to focus engagement on the specific application.
